(19) United States
(12) Patent Application Publication
(10) Pub. No.: US 2018/0196530 A1
(43) Pub. Date: Jul. 12, 2018

(54) METHOD FOR CONTROLLING CURSOR, DEVICE FOR CONTROLLING CURSOR AND DISPLAY APPARATUS

(71) Applicant: BOE TECHNOLOGY GROUP CO., LTD., Beijing (CN)

(72) Inventors: Xin Wang, Beijing (CN); Fan Yang, Beijing (CN); Xuelin Han, Beijing (CN)

(21) Appl. No.: 15/742,023

(22) PCT Filed: Apr. 5, 2017
(86) PCT No.: PCT/CN2017/079427

§ 371 Date: Jan. 4, 2018

(30) Foreign Application Priority Data
Apr. 19, 2016 (CN) 201610244990.2

(51) Int. Cl. G06F 3/038; G06F 3/0354; G06F 3/01; G06K 9/00

(52) U.S. Cl. CPC G06F 3/0383; G06K 9/00268; G06F 3/012; G06F 3/0354

(57) ABSTRACT

The present disclosure provides a method and a device for controlling a cursor, and a display apparatus. The method includes following steps: acquiring characteristic information of a user facing a display screen and determining a coordinate position of the user in a coordinate system in a plane in front of the display screen according to the acquired characteristic information of the user, when a cursor positioning mode is started; determining a sub-area of the display screen corresponding to the coordinate position of the user according to the determined coordinate position of the user in the coordinate system in the plane in front of the display screen and a mapping relationship between the coordinate system in the plane in front of the display screen and a coordinate system in which the display screen is located; and controlling the cursor displayed on the display screen to move to a specified position within the sub-area.

### CROSS-REFERENCE TO RELATED APPLICATION

This application claims the benefit of Chinese Patent Application 201610244990.2 filed on Apr. 19, 2016 in the State Intellectual Property Office of China, the whole disclosure of which is incorporated herein by reference.

### TECHNICAL FIELD

The present disclosure relates to the field of display technologies, and in particular, to a method for controlling a cursor, a device for controlling a cursor and a display apparatus.

### DESCRIPTION OF THE RELATED ART

With the rapid development of display technology, large-size spliced products are widely welcomed in the display market. The conventional spliced product, such as the conventional spliced display, consists of a spliced screen and has a large display size. The mouse cursor is displayed on the screen.

### SUMMARY

According to an aspect of the present disclosure, an embodiment of the present disclosure provides a method for controlling a cursor, comprising:

acquiring characteristic information of a user facing a display screen, and determining a coordinate position of the user in a coordinate system in a plane in front of the display screen according to the acquired characteristic information of the user, when a cursor positioning mode is started;

determining a sub-area corresponding to the coordinate position of the user in the display screen according to the determined coordinate position of the user in the coordinate system in the plane in front of the display screen and the mapping relationship between the coordinate system in the plane in front of the display screen and the coordinate system in which the display screen is located, the sub-area being a sub-area of a plurality of sub-areas pre-divided in the display screen; and

controlling the cursor displayed on the display screen to move to the specified position within the sub-area.

In an exemplary embodiment, in the method provided by the embodiment of the present disclosure, determining a sub-area corresponding to the coordinate position of the user in the coordinate system in the display screen according to the determined coordinate position of the user in the coordinate system in the plane in front of the display screen and the mapping relationship between the coordinate system in the plane in front of the display screen and the coordinate system in which the display screen is located comprises:

determining a first coordinate position of the user in the coordinate system in which the display screen is located according to the determined coordinate position of the user in the coordinate system in the plane in front of the display screen and the mapping relationship between the coordinate system in the plane in front of the display screen and the coordinate system in which the display screen is located;

determining the sub-area in which the first coordinate position is located according to the first coordinate position and a coordinate range corresponding to respective sub-area which is pre-divided in the display screen.

In an exemplary embodiment, in the method provided by the embodiment of the present disclosure, before controlling the cursor displayed on the display screen to move to the specified position within the sub-area, the method further comprises:

acquiring a second coordinate position of the cursor which is currently in the coordinate system in which the display screen is located;

controlling the cursor displayed on the display screen to move to the specified position within the sub-area comprises:

determining a movement displacement of the cursor according to the first coordinate position and the second coordinate position;

controlling the cursor to move to the first coordinate position in the sub-area.

In an exemplary embodiment, in the method provided by the embodiment of the present disclosure, the display screen is a spliced screen, and each sub-screen of the spliced screen serves as a pre-divided sub-area respectively.

In an exemplary embodiment, in the method provided by the embodiment of the present disclosure, acquiring characteristic information of a user facing a display screen, and determining a coordinate position of the user in the coordinate system in a plane in front of the display screen according to the acquired characteristic information of the user, comprises,

acquiring an image comprising facial features of the user facing the display screen and extracting edge features of the user's face from the acquired image;

determining the coordinate position of the center point of the user's face in the coordinate system in the plane in front of the display screen according to the extracted edge features of the user's face, and using the determined coordinate position of the center point of the user's face in the coordinate system in the plane in front of the display screen as the coordinate position of the user in the coordinate system in the plane in front of the display screen.

In an exemplary embodiment, the method provided by the embodiment of the present disclosure further comprises,

turning on the cursor positioning mode when the display screen is turned on for display, or,

turning on the cursor positioning mode when a positioning control signal for controlling the cursor is received.

According to another aspect of the present disclosure, the embodiments of the present disclosure provide a device for controlling a cursor, comprising: a memory for storing executable instructions; and a processor for executing the executable instructions stored in memory, wherein the processor is configured to perform the method described above when the executable instructions are executed.

According to yet another aspect of the present disclosure, the embodiments of the present disclosure provide a device for controlling a cursor, comprising:

a first determination circuit configured to acquire characteristic information of a user facing a display screen, and determine a coordinate position of the user in a coordinate system in a plane in front of the display screen according to the acquired characteristic information of the user, when a cursor positioning mode is started;

a second determination circuit configured to determine a sub-area corresponding to the coordinate position of the user in the display screen according to the determined coordinate position of the user in the coordinate system in the plane in front of the display screen and the mapping relationship between the coordinate system in the plane in front of the display screen and the coordinate system in which the display screen is located, the sub-area being a sub-area of a plurality of sub-areas pre-divided in the display screen;

a cursor controlling circuit configured to control the cursor displayed on the display screen to move to the specified position within the sub-area.

In an exemplary embodiment, in the device provided by the embodiment of the present disclosure, the second determining circuit is specifically configured to determine a first coordinate position of the user in the coordinate system in which the display screen is located according to the determined coordinate position of the user in the coordinate system in the plane in front of the display screen and the mapping relationship between the coordinate system in the plane in front of the display screen and the coordinate system in which the display screen is located; and determine the sub-area in which the first coordinate position is located according to the first coordinate position and a coordinate range corresponding to respective sub-area which is pre-divided in the display screen.

In an exemplary embodiment, the device provided by the embodiment of the present disclosure comprises:

an acquiring circuit configured to acquire a second coordinate position of the cursor which is currently in the coordinate system in which the display screen is located;

the cursor controlling circuit is further configured to determine a movement displacement of the cursor according to the first coordinate position and the second coordinate position; and control the cursor to move to the first coordinate position in the sub-area.

In an exemplary embodiment, in the device provided by the embodiment of the present disclosure, the display screen is a spliced screen, and each sub-screen of the spliced screen serves as a pre-divided sub-area respectively.

In an exemplary embodiment, in the device provided by the embodiment of the present disclosure, the first determination circuit is specifically configured to acquire an image comprising facial features of the user facing the display screen, extract edge features of the user's face from the acquired image, and determine the coordinate position of the center point of the user's face in the coordinate system in the plane in front of the display screen according to the extracted edge features of the user's face, and use the determined coordinate position of the center point of the user's face in the coordinate system in the plane in front of the display screen as the coordinate position of the user in the coordinate system in the plane in front of the display screen.

In an exemplary embodiment, the device provided by the embodiment of the present disclosure further comprises:

a switch circuit configured to turn on the cursor positioning mode when the display screen is turned on for display, or configured to turn on the cursor positioning mode when a positioning control signal for controlling the cursor is received.

According to an aspect of the present disclosure, an embodiment of the present disclosure provides a display apparatus comprising the device described above.

### BRIEF DESCRIPTION OF THE DRAWINGS

FIG. 1 is a flowchart of a method for controlling a cursor according to an embodiment of the present disclosure;

FIG. 2 is a schematic diagram illustrating an application scenario of a method for controlling a cursor according to an embodiment of the present disclosure;

FIG. 3 is a schematic view of a display screen according to an embodiment of the present disclosure;

FIG. 4 is a flowchart of a method for controlling a cursor according to an embodiment of the present disclosure;

FIG. 5 is a block diagram of an exemplary hardware arrangement of a device for controlling a cursor according to an embodiment of the present disclosure; and

FIG. 6 is a schematic block diagram of a device for controlling a cursor according to an embodiment of the present disclosure.

### DETAILED DESCRIPTION OF PREFERRED EMBODIMENTS

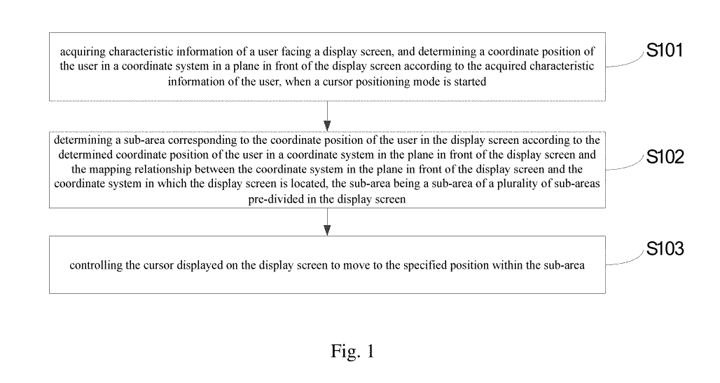

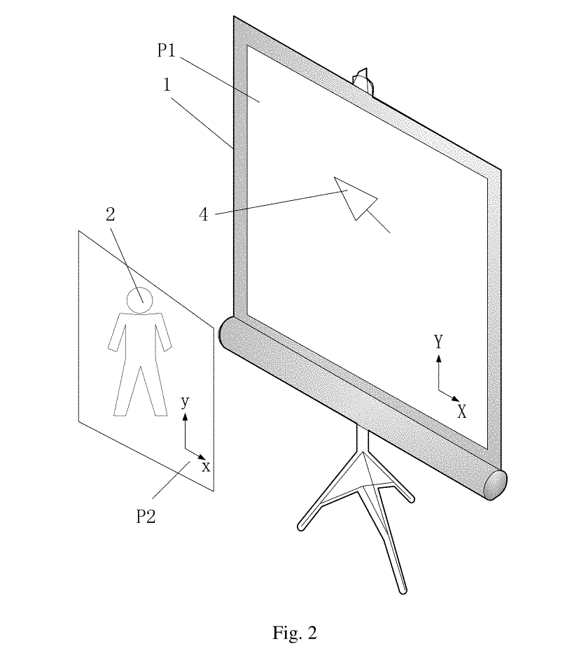

The embodiments of the present disclosure provide a method for controlling a cursor. A flow chart of a method for controlling a cursor according to an embodiment of the present disclosure is shown in FIG. 1. FIG. 2 is a schematic diagram illustrating an application scenario of a method for controlling a cursor according to an embodiment of the present disclosure.

In step S101, when a cursor positioning mode is started, characteristic information of a user 2 facing a display screen 1 is acquired, and a coordinate position of the user 2 in a coordinate system xy in a plane in front of the display screen (for example the plane P2 in FIG. 2) is determined according to the acquired characteristic information of the user.

In step S102, a sub-area corresponding to the coordinate position of the user in the display screen 1 is determined according to the determined coordinate position of the user 2 in the plane P2 in front of the display screen and a mapping relationship between a coordinate system in the plane in front of the display screen (for example the xy coordinate system in plane P2 in FIG. 2) and a coordinate system in which the display screen is located (for example the XY coordinate system in plane P1 in FIG. 2). The sub-area is one of a plurality of sub-areas pre-divided in the display screen 1.

In step S103, the cursor 4 displayed on the display screen 1 is controlled to move to a specified position within the sub-area.

In the method for controlling a cursor according to the embodiment of the present disclosure, the coordinate position of the user is determined according to the characteristic information of the user, so that the cursor is positioned according to the coordinate position of the user, so that the positioned cursor is presented in an area corresponding to the coordinate position of the user and then the user is able to quickly find the cursor to perform subsequent operations, saving time, and ensuring the convenience of operation of the cursor.

Specific embodiments of the above steps will be described in detail below.

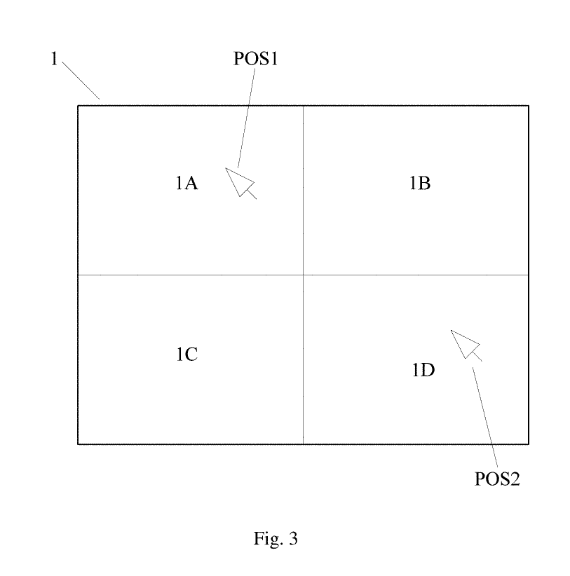

In the above step S102, the determined sub-area in the display screen is a sub-area of a plurality of sub-areas pre-divided in the display screen. For example, as shown in FIG. 3, when the display screen 1 is a large-size spliced screen, each of the sub-screens 1A, 1B, 1C, 1D of the spliced screen may be taken as a sub-area respectively. It is further possible to re-divide the sub-screen of the spliced screen into a plurality of areas, and take the area with the smaller area as the sub-area mentioned above, so as to improve the positioning accuracy of the cursor. Of course, it is also possible to divide the display screen into several areas with a larger area, in order to improve the cursor positioning speed. The manner of dividing the display area and the number of the divided areas in the display screen are not particularly limited in embodiments of the present disclosure.

Specifically, return to refer to FIG. 2, the above step S102, where a sub-area corresponding to the coordinate position of the user in the display screen is determined according to the determined coordinate position of the user in a coordinate system in the plane in front of the display screen and the a mapping relationship between the coordinate system in the plane in front of the display screen and a coordinate system in which the display screen is located, may specifically comprise:

determining a first coordinate position of the user in the coordinate system in which the display screen is located (for example XY coordinate system) according to the determined coordinate position of the user 2 in the plane P2 in front of the display screen 1 and the mapping relationship between the coordinate system in which the determined coordinate position of the user is located (for example xy coordinate system) and the coordinate system in which the display screen is located (for example XY coordinate system); and

determining the sub-area in which the first coordinate position is located according to the first coordinate position and coordinate ranges corresponding to respective sub-areas which are pre-divided in the display screen.

When being specifically implemented, the coordinate range of each of the pre-divided sub-areas in the coordinate system in which the display screen is located may be determined so that the sub-area in which the first coordinate position is located may be positioned quickly when the first coordinate position corresponding to the user in the coordinate system in which the display screen is located is determined. The plane in front of the display screen may be a plane including the user (for example, plane P2 in FIG. 2), which may be parallel to a plane in which the display screen is located (for example, plane P1 in FIG. 2), such that the coordinates of the plane are projected onto the coordinate system in which the display screen is located, and the origin of coordinate of the plane corresponds to the origin of coordinate of the plane in which the display screen is located, so that the points on the plane correspond to the points on the display screen. In addition, according to specific requirements, it is possible to select other plane in front of the display screen and at a preset angle with respect to the display screen and build a mapping relationship between the other plane in front of the display screen and the plane in which the display screen is located. For example, it is possible to take a vertical projection of the plane in the front of the display screen onto the plane in which the display screen is located as the mapping relationship between the two planes so that the parts in the two planes correspond to each other. Other manners for establishing the mapping relationship are not limited in the embodiments of the present disclosure.

Further, before above step S103, the method for controlling a cursor provided by the embodiments of the present disclosure further comprises a following step:

acquiring a second coordinate position of the cursor which is currently in the coordinate system in which the display screen is located, for example, the second coordinate position POS2 located in the area 1D shown in FIG. 3.

Further, the above step S103, where the cursor displayed on the display screen is controlled to move to a specified position within the sub-area, may specifically comprise:

determining a movement displacement of the cursor according to the first coordinate position (for example, the first coordinate position POS1 located in the area 1A shown in FIG. 3) and the second coordinate position(for example, the second coordinate position POS2 located in the area 1D shown in FIG. 3); and

controlling the cursor to move to the first coordinate position in the sub-area.

Since the above mentioned first coordinate position and the second coordinate position are two points of the coordinate system in which the display screen is located, the displacement that the cursor needs to move may be determined through the coordinate position of the two points so that the first coordinate position may be assigned to the cursor and then the cursor may be displayed at a new coordinate position, i.e. the first coordinate position which is determined by the position of the user facing the display screen. Therefore, the cursor of the display screen will move to the sub-area of the display screen faced by the user, so that the user may quickly find the cursor, ensuring the convenience of operation of the cursor.

When being specifically implemented, the above Step S101, where characteristic information of a user facing a display screen is acquired, and a coordinate position of the user in the coordinate system in a plane in front of the display screen is determined according to the acquired characteristic information of the user, may specifically comprise:

acquiring an image comprising facial features of the user facing the display screen and extracting edge features of the user's face from the acquired image;

determining a coordinate position of the center point of the user's face in the coordinate system in the plane in front of the display screen according to the extracted edge features of the user's face, and using the determined coordinate position of the center point of the user's face in the coordinate system in the plane in front of the display screen as the coordinate position of the user in the coordinate system in the plane in front of the display screen.

Specifically, after the edge features of the user's face are extracted, the extracted edge features are subjected to a least square ellipse fitting, and then in combination with the ratio between the width and height of the user's face, a threshold range of the user's face in the coordinate system of the plane in front of the display screen is determined, such that the coordinate position of the center point of the user's face in the coordinate system in the plane is calculated and is further mapped onto the coordinate system in which the display screen is located, thereby determining the above-mentioned first coordinate position. When being specifically implemented, Sobel operator, Rbert operator, Prewitt operator, LOG operator or Canny operator may be used to extract the edge features of the user's face. In addition, other algorithms for extracting the user's edge features and the algorithms for calculating the center point of the user's face may still be selected, which is not limited herein. According to actual requirements, the characteristic information of other parts of the user may also be selected as the basis for determining the coordinate position of the user, which is not limited in the embodiments of the present disclosure.

When being specifically implemented, the method for controlling a cursor provided by the embodiments of the present disclosure further comprises following steps:

turning on a cursor positioning mode when the display screen is turned on for display, or,

turning on the cursor positioning mode when a positioning control signal for controlling the cursor is received.

For example, the cursor positioning mode is turned on when a positioning control signal that indicates the user double-clicks the mouse wheel is received, and the cursor positioning mode is exited and the mouse may be used to control cursor for normal operation when a positioning control signal that indicates the user double-clicks the mouse wheel is received again. The measures for turning on and off the cursor positioning mode may also be keyboard shortcuts, controllers and other devices, which is not limited in the embodiments of the present disclosure.

In an optional embodiment, the method for controlling a cursor provided by the embodiments of the present disclosure may be utilized to perform rapid cursor movement. For example, when the user wants to quickly move the cursor to a certain position on the display screen, the user may face the position and turn on the cursor positioning mode. The cursor can be quickly moved to the sub-area of the display screen corresponding to centerpoint of the user's face through the above method, thereby further improving the convenience of the operation of the cursor.

In the following, a method for controlling a cursor provided by the embodiment of the present disclosure is specifically described in an example.

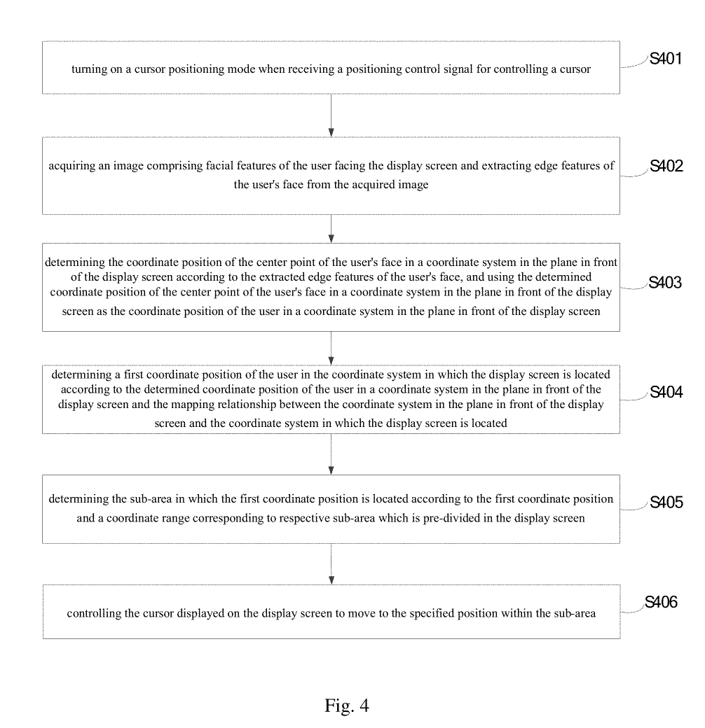

The specific implementation process is shown in FIG. 4, which specifically includes the following steps:

S401, turning on a cursor positioning mode when receiving a positioning control signal for controlling a cursor;

S402, acquiring an image comprising facial features of the user facing the display screen and extracting edge features of the user's face from the acquired image;

S403, determining the coordinate position of the center point of the user's face in a coordinate system in the plane in front of the display screen according to the extracted edge features of the user's face, and using the determined coordinate position of the center point of the user's face in the coordinate system in the plane in front of the display screen as the coordinate position of the user in the coordinate system in the plane in front of the display screen;

S404, determining a first coordinate position of the user in the coordinate system in which the display screen is located according to the determined coordinate position of the user in the coordinate system in the plane in front of the display screen and a mapping relationship between the coordinate system in which the determined coordinate position of the user is located and a coordinate system in which the display screen is located;

S405, determining a sub-area in which the first coordinate position is located according to the first coordinate position and coordinate ranges corresponding to respective sub-areas which are pre-divided in the display screen; and

S406, controlling the cursor displayed on the display screen to move to a specified position within the sub-area.

Based on the same inventive concept, embodiments of the present disclosure provide a device for controlling a cursor. Since the principle for solving the problem by the device is similar to the foregoing method for controlling a cursor, the implementation of the device may refer to the implementation of the method, and details are not described herein again.

According to another exemplary embodiment of the present disclosure, there is further provided a device for controlling a cursor comprising: a memory for storing executable instructions; and a processor for executing the executable instructions stored in memory, so as to perform the method described above.

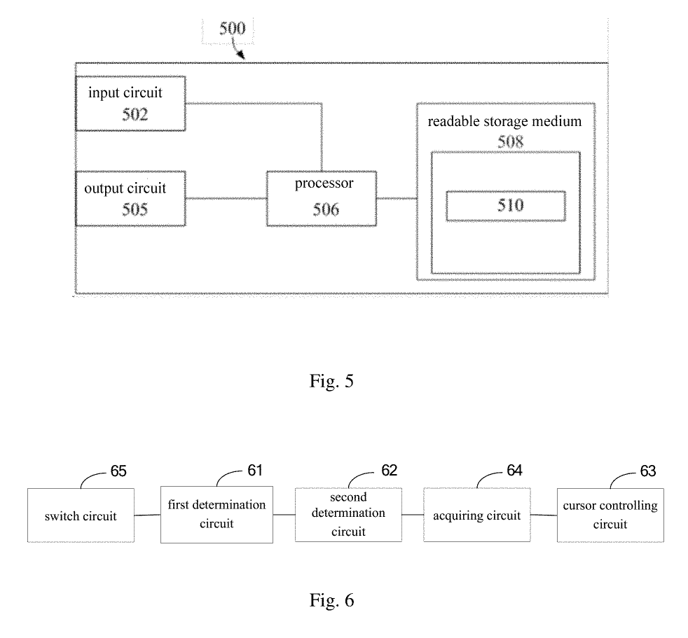

FIG. 5 shows a block diagram of an exemplary hardware arrangement 500 for controlling a cursor according to an embodiment of the disclosure. The hardware arrangement 500 includes a processor 506 (for example a microprocessor (μP), a digital signal processor (DSP), etc.). The processor 506 may be a single processing circuit or a plurality of processing circuits for performing different actions of the processes described herein. Arrangement 500 may also include an input circuit 502 for receiving signals from other entities and an output circuit 505 for providing signals to other entities. The input circuit 502 and the output circuit 505 may be arranged as a single entity or as separate entities.

In addition, the arrangement 500 may include at least one readable storage medium 508 in the form of non-volatile or volatile memory, such as electrically erasable programmable read-only memory (EEPROM), flash memory, and/or a hard disk drive. The readable storage medium 508 includes a computer program 510 that includes code/computer readable instructions that, when executed by the processor 506 in the arrangement 500, cause the hardware arrangement 500 and/or the apparatus including the hardware arrangement 500 to perform, for example, the processes described above in connection with FIGS. 1-4 and any variations thereof.

Although the code means in the embodiments disclosed above in connection with FIG. 5 are implemented as computer program modules that when executed in the processor 506 cause the hardware arrangement 500 to perform the steps described above in connection with FIGS. 1-4, at least one of the code means may be at least partially implemented as a hardware circuit.

The processor may be a single CPU (Central Processing Unit), but may also include two or more processing circuits. For example, the processor may include a general purpose microprocessor, an instruction set processor and/or related chipsets and/or a special purpose microprocessor (for example, an application specific integrated circuit (ASIC)). The processor may also include on-board memory for caching purposes. The computer program may be carried by a computer program product connected to the processor. The computer program product may include a computer readable medium having a computer program stored thereon. For example, the computer program product may be a flash memory, a random access memory (RAM), a read only memory (ROM), an EEPROM, and in alternative embodiments may be distributed to different computer program products in the form of memory within the UE.

According to another exemplary embodiment of the present disclosure, there is further provided a device for controlling a cursor, a schematic diagram of which is shown in FIG. 6, and which may specifically comprises:

a first determination circuit 61 configured, when a cursor positioning mode is started, to acquire characteristic information of a user facing a display screen, and to determine a coordinate position of the user in a coordinate system in a plane in front of the display screen according to the acquired characteristic information of the user;

a second determination circuit 62 configured to determine a sub-area of the display screen corresponding to the coordinate position of the user according to the determined coordinate position of the user in the coordinate system in the plane in front of the display screen and the a mapping relationship between a coordinate system in which the determined coordinate position of the user is located and a coordinate system in which the display screen is located, the sub-area being a sub-area of a plurality of sub-areas pre-divided in the display screen; and

a cursor controlling circuit 63 configured to control the cursor displayed on the display screen to move to a specified position within the sub-area.

Specifically, the second determining circuit 62 may be further configured to determine a first coordinate position of the user in the coordinate system in which the display screen is located according to the determined coordinate position of the user in the coordinate system in the plane in front of the display screen and the mapping relationship between the coordinate system in which the determined coordinate position of the user is located and the coordinate system in which the display screen is located, and to determine the sub-area in which the first coordinate position is located according to the first coordinate position and to coordinate ranges corresponding to respective sub-areas which are pre-divided in the display screen.

Further, the device provided by the embodiment of the present disclosure may comprise:

an acquiring circuit 64 configured to acquire a second coordinate position of the cursor which is currently in the coordinate system in which the display screen is located.

Correspondingly, the cursor controlling circuit 63 is further configured to determine a movement displacement of the cursor according to the first coordinate position and the second coordinate position, and to control the cursor to move to the first coordinate position in the sub-area.

Specifically, the first determination circuit 61 may be configured to acquire an image comprising facial features of the user facing the display screen, extract edge features of the user's face from the acquired image, and determine the coordinate position of the center point of the user's face in the coordinate system in the plane in front of the display screen according to the extracted edge features of the user's face, and use the determined coordinate position of the center point of the user's face in the coordinate system in the plane in front of the display screen as the coordinate position of the user in the coordinate system in the plane in front of the display screen.

The device for controlling a cursor provided by the embodiment of the present disclosure may further comprise:

a switch circuit 65 configured to turn on the cursor positioning mode when the display screen is turned on for display, or configured to turn on the cursor positioning mode when a positioning control signal for controlling the cursor is received.

The embodiments of the present disclosure provide a display apparatus comprising the device for controlling a cursor described above. The display apparatus may be any product or component having a display function, such as a liquid crystal panel, an electronic paper, an OLED panel, a cell phone, a tablet computer, a television, a display, a notebook computer, a digital photo frame, a navigator.

Through the description of the foregoing implementation manners, those skilled in the art may clearly understand that the embodiments of the present disclosure may be implemented by hardware or by means of software plus a necessary universal hardware platform. For example, the functions implemented by respective circuits may be integrated into a processor chip, and the image of the user's characteristic may be obtained by using somatosensory identification camera, and is sent to the processor chip to determine the coordinate position of the user. The processor chip can also be installed in the display apparatus so that the display apparatus has the function of positioning the cursor.

Embodiments of the present disclosure provide a method for controlling a cursor, a device for controlling a cursor and a display apparatus, where when a cursor positioning mode is started, characteristic information of a user facing a display screen is acquired, and a coordinate position of the user in a coordinate system in a plane in front of the display screen is determined according to the acquired characteristic information of the user; a sub-area of the display screen corresponding to the coordinate position of the user is determined according to the determined coordinate position of the user in the coordinate system in the plane in front of the display screen and a mapping relationship between a coordinate system in which the determined coordinate position of the user is located and a coordinate system in which the display screen is located, the sub-area being a sub-area of a plurality of sub-areas pre-divided in the display screen; and the cursor displayed on the display screen is controlled to move to a specified position within the sub-area. According to the method and the device for controlling cursor as well as the display apparatus provided by the embodiments of the present disclosure, the coordinate position of the user is determined according to the characteristic information of the user, so that the cursor is positioned according to the coordinate position of the user, thereby the positioned cursor is presented in an area corresponding to the coordinate position of the user and then the user is able to quickly find the cursor to perform subsequent operations, saving time, and ensuring the convenience of operation of the cursor.

Obviously, those skilled in the art can make various modifications and variations to the present disclosure without departing from the spirit and scope of the disclosure. In this way, if these modifications and variations of the disclosure fall within the scope of the claims and the equivalents thereof of the disclosure, the disclosure is also intended to include these modifications and variations.

1. A method for controlling a cursor, comprising:
acquiring characteristic information of a user facing a display screen and determining a coordinate position of the user in a coordinate system in a plane in front of the display screen according to the acquired characteristic information of the user, when a cursor positioning mode is started;
determining a sub-area of the display screen corresponding to the coordinate position of the user according to the determined coordinate position of the user in the coordinate system in the plane in front of the display screen and a mapping relationship between the coordinate system in the plane in front of the display screen and a coordinate system in which the display screen is located, the sub-area being one of a plurality of sub-areas pre-divided in the display screen; and
controlling the cursor displayed on the display screen to move to a specified position within the sub-area.

2. The method according to claim 1, wherein determining the sub-area of the display screen corresponding to the coordinate position of the user according to the determined coordinate position of the user in the coordinate system in the plane in front of the display screen and the mapping relationship between the coordinate system in the plane in front of the display screen and the coordinate system in which the display screen is located comprises:
determining a first coordinate position of the user in the coordinate system in which the display screen is located according to the determined coordinate position of the user in the coordinate system in the plane in front of the display screen and the mapping relationship between the coordinate system in the plane in front of the display screen and the coordinate system in which the display screen is located; and
determining the sub-area in which the first coordinate position is located according to the first coordinate position and coordinate ranges corresponding to respective sub-areas which are pre-divided in the display screen.

3. The method according to claim 2, wherein before controlling the cursor displayed on the display screen to move to a specified position within the sub-area, the method further comprises:
acquiring a second coordinate position of the cursor which is currently in the coordinate system in which the display screen is located; and
the controlling the cursor displayed on the display screen to move to a specified position within the sub-area comprises:
determining a movement displacement of the cursor according to the first coordinate position and the second coordinate position; and
controlling the cursor to move to the first coordinate position in the sub-area.

4. The method according to claim 1, wherein the display screen is a spliced screen, and sub-screens of the spliced screen serve as the pre-divided sub-areas respectively.

5. The method according to claim 1, wherein acquiring characteristic information of the user facing the display screen and determining the coordinate position of the user in the coordinate system in the plane in front of the display screen according to the acquired characteristic information of the user comprises:
acquiring an image comprising facial features of the user facing the display screen and extracting edge features of the user's face from the acquired image;
determining a coordinate position of the center point of the user's face in the coordinate system in the plane in front of the display screen according to the extracted edge features of the user's face, and using the determined coordinate position of the center point of the user's face in the coordinate system in the plane in front of the display screen as the coordinate position of the user in the coordinate system in the plane in front of the display screen.

6. The method according to claim 1, wherein the method further comprises:
turning on the cursor positioning mode when the display screen is turned on for display, or,
turning on the cursor positioning mode when a positioning control signal for controlling the cursor is received.

7. A device for controlling a cursor, comprising:
a memory for storing executable instructions; and
a processor for executing the executable instructions stored in memory,
wherein the processor is configured to perform the method according to claim 1 when the executable instructions are executed.

8. A device for controlling a cursor, comprising:
a first determination circuit configured, when a cursor positioning mode is started, to acquire characteristic information of a user facing a display screen, and to determine a coordinate position of the user in a coordinate system in a plane in front of the display screen according to the acquired characteristic information of the user;
a second determination circuit configured to determine a sub-area of the display screen corresponding to the coordinate position of the user according to the determined coordinate position of the user in the coordinate system in the plane in front of the display screen and to a mapping relationship between the coordinate system in the plane in front of the display screen and a coordinate system in which the display screen is located, the sub-area being one of a plurality of sub-areas pre-divided in the display screen; and
a cursor controlling circuit configured to control the cursor displayed on the display screen to move to a specified position within the sub-area.

9. The device according to claim 8, wherein the second determining circuit is specifically configured to:
determine a first coordinate position of the user in the coordinate system in which the display screen is located according to the determined coordinate position of the user in the coordinate system in the plane in front of the display screen and to the mapping relationship between the coordinate system in the plane in front of the display screen and the coordinate system in which the display screen is located; and
determine the sub-area in which the first coordinate position is located according to the first coordinate position and coordinate ranges corresponding to respective sub-areas which are pre-divided in the display screen.

10. The device according to claim 9, further comprising:
an acquiring circuit configured to acquire a second coordinate position of the cursor which is currently in the coordinate system in which the display screen is located;
wherein the cursor controlling circuit is further configured to determine a movement displacement of the cursor according to the first coordinate position and the second coordinate position and to control the cursor to move to the first coordinate position in the sub-area.

11. The device according to claim 8, wherein the display screen is a spliced screen, and sub-screens of the spliced screen serve as the pre-divided sub-areas respectively.

12. The device according to claim 8, wherein the first determination circuit is specifically configured to:
acquire an image comprising facial features of the user facing the display screen,
extract edge features of the user's face from the acquired image,
determine a coordinate position of the center point of the user's face in the coordinate system in the plane in front of the display screen according to the extracted edge features of the user's face, and
use the determined coordinate position of the center point of the user's face in the coordinate system in the plane in front of the display screen as the coordinate position of the user in the coordinate system in the plane in front of the display screen.

13. The device according to claim 8, further comprising:
a switch circuit configured to turn on the cursor positioning mode when the display screen is turned on for display, or configured to turn on the cursor positioning mode when a positioning control signal for controlling the cursor is received.

14. A display apparatus comprising the device according to claim 7.

15. The method according to claim 2, wherein acquiring characteristic information of the user facing the display screen and determining the coordinate position of the user in the coordinate system in the plane in front of the display screen according to the acquired characteristic information of the user comprises:
acquiring an image comprising facial features of the user facing the display screen and extracting edge features of the user's face from the acquired image;
determining a coordinate position of the center point of the user's face in the coordinate system in the plane in front of the display screen according to the extracted edge features of the user's face, and using the determined coordinate position of the center point of the user's face in the coordinate system in the plane in front of the display screen as the coordinate position of the user in the coordinate system in the plane in front of the display screen.

16. A device for controlling a cursor, comprising:
a memory for storing executable instructions; and
a processor for executing the executable instructions stored in memory,
wherein the processor is configured to perform the method according to claim 2 when the executable instructions are executed.

17. The device according to claim 9, wherein the first determination circuit is specifically configured to:
acquire an image comprising facial features of the user facing the display screen, extract edge features of the user's face from the acquired image,
determine a coordinate position of the center point of the user's face in the coordinate system in the plane in front of the display screen according to the extracted edge features of the user's face, and
use the determined coordinate position of the center point of the user's face in the coordinate system in the plane in front of the display screen as the coordinate position of the user in the coordinate system in the plane in front of the display screen.

18. A display apparatus comprising the device according to claim 16.

19. A display apparatus comprising the device according to claim 8.

20. A display apparatus comprising the device according to claim 9.
